(19) United States
(12) Patent Application Publication
(10) Pub. No.: US 2022/0058407 A1
(43) Pub. Date: Feb. 24, 2022

(54) Neural Network For Head Pose And Gaze Estimation Using Photorealistic Synthetic Data

(71) Applicant: Huawei Technologies Co., Ltd., Shenzhen (CN)

(72) Inventors: Lei Yang, San Diego, CA (US); Yuan Ma, Plano, TX (US); Wenxin Shao, Plano, TX (US); Wei Huang, Plano, TX (US); Fatih Porikli, Plano, TX (US)

(21) Appl. No.: 17/518,283

(22) Filed: Nov. 3, 2021

Related U.S. Application Data
(63) Continuation of application No. PCT/US2019/032047, filed on May 13, 2019.

(51) Int. Cl. G06K 9/00; G06K 9/62; G06T 7/30; G06T 7/11; G06T 17/00; G06T 11/00; G06T 15/04; G06N 3/08; G06N 3/04

(52) U.S. Cl. CPC G06K 9/00845; G06K 9/6257; G06K 9/00597; G06T 7/30; G06T 7/11; G06T 17/00; G06T 2207/20084; G06T 15/04; G06N 3/08; G06N 3/0454; G06T 2207/20132; G06T 2207/20081; G06T 11/001

(57) ABSTRACT

The disclosure provides for head pose and gaze angle estimation that includes using a face alignment method with an image of a two-dimensional (2D) face to generate a facial UV position image and facial UV texture image of the 2D face in which to decouple movement of the head and eyes of the 2D face. An eye UV texture image is extracted from the facial UV texture image and stored in a database. The eye region of the facial UV texture image may then be replaced with the eye UV texture image stored in the database to generate a modified facial UV texture image. The modified facial UV texture image is reconstructed to generate a modified 2D face image as training data stored in the database, and the head pose and gaze angles of a person are simultaneously estimated by training a convolutional neural network with the training data.

### CROSS-REFERENCE TO RELATED APPLICATIONS

This application is a continuation of International Application No. PCT/US2019/032047 filed on May 13, 2019 by Futurewei Technologies, Inc., and titled “A Neural Network For Head Pose And Gaze Estimation Using Photorealistic Synthetic Data,” which is hereby incorporated by reference.

### TECHNICAL FIELD

The disclosure generally relates to training neural networks, and in particular, to training a neural network with a dataset to estimate a head pose and gaze angle of a person driving a vehicle.

### BACKGROUND

Driver distraction is increasingly becoming a leading cause of vehicular accidents, particularly with the increased use of technology such as mobile devices, which divert the driver's attention away from the road. Driver distraction monitoring and avoidance is critical in assuring a safe driving environment not only for the distracted driver, but also for other drivers in the vicinity that may be affected by the distracted driver. Vehicles with the ability to monitor a driver allow for measures to be taken by the vehicle to prevent or assist in preventing accidents as a result of the driver being distracted. For instance, warning systems can be enabled to alert the driver that she is distracted or automatic features, such as braking and steering, may be enabled to bring the vehicle under control until such time the driver is no longer distracted. To detect driver distraction, these warning and preventative monitoring systems may use head pose and gaze angles of a driver to evaluate the current status. However, as head and eye movement are typically independent from one another, accurate head pose and gaze estimation is a non-trivial challenge in computer vision technology.

### SUMMARY

According to one aspect of the present disclosure, there is provided a computer-implemented method for head pose and gaze angle estimation, comprising training a first neural network with a plurality of two-dimensional (2D) face images in which to decouple movement of the head and eyes of the 2D face, the training of the first network including mapping a 2D face from the plurality of 2D face images to a facial position image, and constructing a facial texture image of the 2D face based on the facial position image; storing an eye texture image, including gaze angles, extracted from the facial texture image of the 2D face in a database; replacing an eye region of the facial texture image with the eye texture image, including the gaze angles, stored in the database to generate a modified facial texture image; reconstructing the modified facial texture image to generate a modified 2D face image, including a modified head pose and gaze angle, as training data and storing the training data in the database; and estimating the head pose and gaze angles by training a second neural network with the training data, the training of the second neural network including collecting the training data from the database, and simultaneously applying one or more transformations to the modified 2D face images and a corresponding eye region of the modified 2D face images of the training data.

Optionally, in any of the preceding aspects, wherein the mapping further includes mapping the 2D face in the plurality of 2D face images to a position map using a face alignment method, where the facial position image aligns the 2D face in the plurality of 2D face images to three-dimensional (3D) coordinates of a reconstructed 3D model for the 2D face in the plurality of 2D face images; and the constructing further includes constructing, based on the facial position image or a face 3D morphable model, the facial texture image for the 2D face in the plurality of 2D face images to indicate a texture of the aligned 2D face.

Optionally, in any of the preceding aspects, the storing further includes extracting the facial texture image from the 2D face in the plurality of 2D face images based on the facial position image; cropping the eye region from the facial texture image to create a cropped eye texture image based on landmarks from the aligned 2D face in the plurality of 2D face images; and storing the cropped eye texture image into the database.

Optionally, in any of the preceding aspects, wherein the cropped eye ultra violet (UV) texture image is labelled as a difference between the head pose and the gaze angle of the 2D face in the plurality of 2D face images.

Optionally, in any of the preceding aspects, the replacing further includes selecting the eye region from the cropped eye texture image based on the landmarks from the database; and replacing the eye region in the facial texture image with the cropped eye texture image from the database based on aligned coordinates of the landmarks to generate a modified facial texture map of the 2D face in the plurality of 2D face images.

Optionally, in any of the preceding aspects, the replacing further includes applying image fusion to merge the cropped eye texture image selected from the database into the modified facial texture map of the 2D face in the plurality of 2D face images; and training a generative adversarial network (GAN) or using a local gradient information-based method to smooth color and texture in the eye region of the modified facial texture image.

Optionally, in any of the preceding aspects, the computer-implemented method further includes warping the modified facial texture image of the 2D face onto a 3D face morphable model (3DMM) to reconstruct a 3D face model with the gaze direction from the modified facial texture image; applying a rotation matrix to the reconstructed 3D face model to change the head pose, and changing the gaze angles to be consistent with the head pose; projecting the 3D face model after application of the rotation matrix to a 2D image space to generate the modified 2D face image; and storing the modified 2D face image in the database.

Optionally, in any of the preceding aspects, wherein the gaze direction is calculated by adding a relative gaze direction stored in the cropped eye texture image selected from the database to the head pose.

Optionally, in any of the preceding aspects, wherein the estimating further includes collecting 2D face images of a driver of a vehicle with one or more head poses to generate a driver dataset; and applying the driver dataset to fine-tune the second neural network to estimate the head pose and gaze angle estimation of the driver.

Optionally, in any of the preceding aspects, wherein the 2D face images of the driver are captured with a capture device and uploaded to a network for processing; and the processed 2D face images of the driver are downloaded to the vehicle.

Optionally, in any of the preceding aspects, wherein the first neural network is an encoder-decoder type neural network to map the 2D face image to a corresponding position map.

Optionally, in any of the preceding aspects, wherein in the facial position image, red green blue (RGB) gray-values at each pixel indicate 3D coordinates of the corresponding facial point in its reconstructed 3D model.

According to still one other aspect of the present disclosure, there is a device for head pose and gaze angle estimation, comprising a non-transitory memory storage comprising instructions; and one or more processors in communication with the memory, wherein the one or more processors execute the instructions to train a first neural network with a plurality of two-dimensional (2D) face images in which to decouple movement of the head and eyes of the 2D face, the training of the first network including mapping a 2D face from the plurality of 2D face images to a facial position image, and constructing a facial texture image of the 2D face based on the facial position image; store an eye texture image, including gaze angles, extracted from the facial texture image of the 2D face in a database; replace an eye region of the facial texture image with the eye texture image, including the gaze angles, stored in the database to generate a modified facial texture image; reconstruct the modified facial texture image to generate a modified 2D face image, including a modified head pose and gaze angle, as training data and storing the training data in the database; and estimate the head pose and gaze angles by training a second neural network with the training data, the training of the second neural network including collecting the training data from the database, and simultaneously applying one or more transformations to the modified 2D face images and a corresponding eye region of the modified 2D face images of the training data.

According to still one other aspect of the present disclosure, there is a non-transitory computer-readable medium storing computer instructions for head pose and gaze angle estimation, that when executed by one or more processors, cause the one or more processors to perform the steps of training a first neural network with a plurality of two-dimensional (2D) face images in which to decouple movement of the head and eyes of the 2D face, the training of the first network including mapping a 2D face from the plurality of 2D face images to a facial position image, and constructing a facial texture image of the 2D face based on the facial position image; storing an eye texture image, including gaze angles, extracted from the facial texture image of the 2D face in a database; replacing an eye region of the facial texture image with the eye texture image, including the gaze angles, stored in the database to generate a modified facial texture image; reconstructing the modified facial texture image to generate a modified 2D face image, including a modified head pose and gaze angle, as training data and storing the training data in the database; and estimating the head pose and gaze angles by training a second neural network with the training data, the training of the second neural network including collecting the training data from the database, and simultaneously applying one or more transformations to the modified 2D face images and a corresponding eye region of the modified 2D face images of the training data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate like elements.

FIG. 1A illustrates a system for head pose and gaze estimation according to an embodiment of the present technology.

FIG. 1B illustrates an example head pose and gaze estimator in accordance with FIG. 1A.

FIG. 2A illustrates an example flow diagram for estimating head pose and gaze angles in accordance with embodiments of the disclosure.

FIG. 2B illustrates an example of an origin and coincident head pose and gaze.

FIGS. 2C and 2D illustrate training a neural network for two-dimensional (2D) face data.

FIGS. 3A and 3B illustrate an example of constructing an eye UV texture dataset.

FIGS. 4A and 4B illustrate an example of replacing an eye region in the facial UV texture image.

FIGS. 5A and 5B illustrate an example flow diagram of 3D face reconstruction and training data generation.

FIG. 6 illustrates an example of a multimodal CNN for estimating head pose and gaze angle.

FIGS. 7A and 7B illustrate flow diagrams to fine-tune a pre-trained model.

FIG. 8 illustrates a computing system upon embodiments of the disclosure may be implemented.

### DETAILED DESCRIPTION

The present disclosure will now be described with reference to the figures, which in general relate to a driver behavior detection.

A head pose and gaze estimation technique is disclosed in which the movement of the head may be de-coupled from movement of a gaze in a two-dimensional (2D) face image. A face alignment method, such as a deep neural network (DNN)), is used to align the head pose and map the 2D face image from 2D image space to a new UV space. The new UV space is a 2D image plane parameterized from the 3D space and is utilized to express a three-dimensional (3D) geometry (UV position image) and the corresponding texture of the 2D face image (UV texture image). The UV texture image may be used to crop eye regions (with different gaze angles) and create a dataset of eye UV texture images in a database. For any 2D face image (for example, a front view face image), the eye region in its UV texture image can be replaced with any image in the eye UV texture dataset stored in the database. The face image may then be reconstructed from the UV space to 3D space. A rotation matrix is then applied to the new 3D face and projected back to 2D space to synthesize a large amount of new photorealistic images with different head pose and gaze angles. The photorealistic images may be used to train a multimodal convolution neural network (CNN) for simultaneous head pose and gaze angle estimation. The technique may also be applied to other facial attributes, such as expression or fatigue, to generate on datasets related, but not limited to, yawning, eye closure, etc.

It is understood that the present embodiments of the disclosure may be implemented in many different forms and that claim scope should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

Data-driven DNN technology has been one of the most remarkable advancements of the last decade, particularly as it relates to computer vision. For DNN training, large datasets with accurate labels is of essential importance. However, there are no readily available large head pose and gaze angle datasets with sufficient amounts of data to perform such training. This is due primarily to the need of an experimental environment in which to collect and acquire the data acquisition. For example, a commonly used dataset is the Columbia gaze dataset, which was collected using a well-designed camera array and a chin rest with a number of fixed head poses. While the Columbia gaze dataset is a good public dataset for algorithm research, it remains insufficient to train a stable gaze and head pose estimation network. An explanation of the Columbia gaze data is disclosed in “Gaze Locking: Passive Eye Contact Detection for Human-Object Interaction,” B. A. Smith et al., published October 2013.

As another example, and one of todays most advanced remote gaze analyzers, is the SmartEye Ab® eye tracking system. This system is capable of estimating a person's head pose and gaze accurately and non-invasively. However, it has many shortcomings, including a complicated calibration for the imaging system and only near infrared (NIR) images can be provided for training and testing, the head pose and gaze estimation results are geometric computation-based and very sensitive to the parameter drifting of the imaging system, and the imaging system is very expensive.

Due to the above-mentioned and other limitations of training datasets, head pose and gaze estimation tasks are commonly considered as two separated tasks in the field of computer vision.

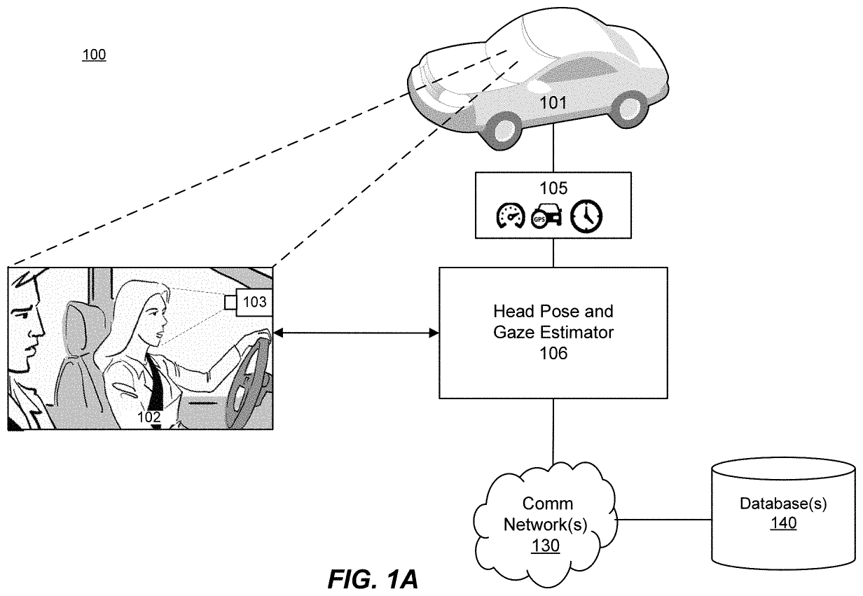

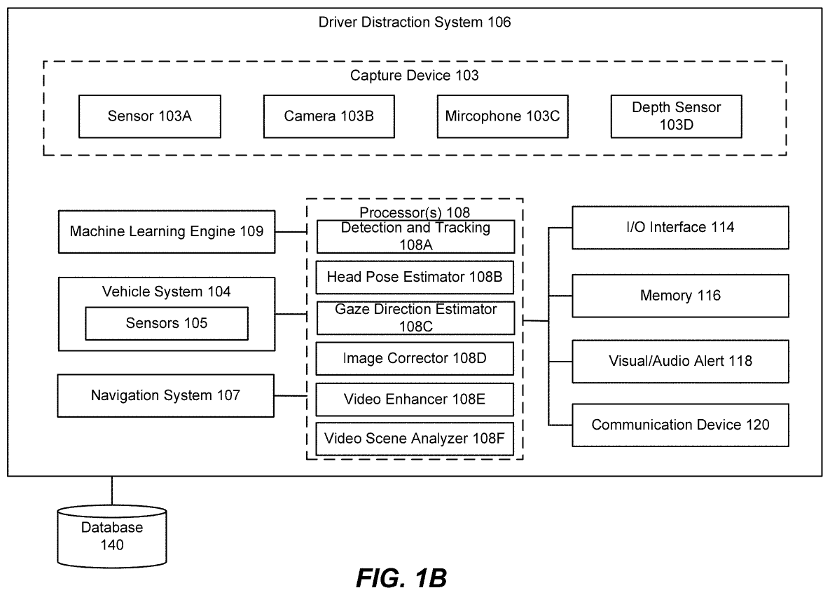

FIG. 1A illustrates a driver distraction system 100 for head pose and gaze estimation according to an embodiment of the present technology. The head pose and gaze estimator 106 is shown as being installed or otherwise included within a vehicle 101 that also includes a cabin within which a driver 102 can sit. The head pose and gaze estimator 106, or one or more portions thereof, can be implemented by an in-cabin computer system, and/or by a mobile computing device, such as, but not limited to, a smartphone, tablet computer, notebook computer, laptop computer, and/or the like.

In accordance with certain embodiments of the present technology, the head pose and gaze estimator 106 obtains, from one or more sensors, current data for a driver 102 of a vehicle 101. In other embodiments, the head pose and gaze estimator 106 also obtains, from one or more databases 140, additional information about the driver 102 as it relates to features of the driver, such as facial features, historical head pose and eye gaze information, etc. The head pose and gaze estimator 106 analyzes the current data and/or the additional information for the driver 102 of the vehicle 101 to thereby identify a driver's head pose and eye gaze. Such analysis may be performed using one or more computer implemented neural network and/or some other computer implemented model, as explained below.

As shown in FIG. 1A, the head pose and gaze estimator 106 is communicatively coupled to a capture device 103, which may be used to obtain current data for the driver of the vehicle 101. In one embodiment, the capture device 103 includes sensors and other devices that are used to obtain current data for the driver 102 of the vehicle 101. The captured data may be processed by processor(s) 108 of FIG. 1B, which includes hardware and/or software to detect and track driver movement, head pose and gaze direction. As will be described in additional detail below, with reference to FIG. 1B, the capture device may additionally include one or more cameras, microphones or other sensors to capture data.

In one embodiment, the capture device 103 can be external to the driver distraction system 106, as shown in FIG. 1A, or can be included as part of the driver distraction system 106, depending upon the specific implementation. Additional details of the driver distraction system 106, according to certain embodiments of the present technology, are described below with reference to FIG. 1B.

Still referring to FIG. 1A, the head pose and gaze estimator 106 is also shown as being communicatively coupled to various different types of vehicle related sensors 105 that are included within the vehicle 101. Such sensors 105 can include, but are not limited to, a speedometer, a global positioning system (GPS) receiver, and a clock. The head pose and gaze estimator 106 is also shown as being communicatively coupled to one or more communication network(s) 130 that provide access to one or more database(s) 140 and/or other types of data stores. The database(s) 140 and/or other types of data can store vehicle data for the vehicle 101. Examples of such data include, but are not limited to, driving record data, driving performance data, driving license type data, driver facial features, drive head pose, driver gaze, etc. Such data can be stored within a local database or other data store that is located within the vehicle 101. However, the data is likely stored in one or more database(s) 140 or other data store(s) remotely located relative to the vehicle 101. Accordingly, such database(s) 140 or other data store(s) can be communicatively coupled to the driver distraction system via one or more communication networks(s) 130.

The communication network(s) 130 can include a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof. The communication network(s) 130 can provide communication capabilities between the driver distraction system 106 and the database(s) 140 and/or other data stores, for example, via communication device 120 (FIG. 1B).

While the embodiments of FIG. 1A are described with reference to a vehicle 101, it is appreciated that the disclosed technology may be employed in a wide range of technological areas and is not limited to vehicles. For example, in addition to vehicles, the disclosed technology could be used in virtual or augmented reality devices or in simulators in which head pose and gaze estimations, vehicle data and/or scene information may be required.

Additional details of the driver distraction system 106, according to certain embodiments of the present technology, will now be described with reference to FIG. 1B. The driver distraction system 106 includes a capture device 103, one or more processors 108, a vehicle system 104, a navigation system 107, a machine learning engine 109, an input/output (I/O) interface 114, a memory 116, a visual/audio alert 118, a communication device 120 and database 140 (which may also be part of the driver distraction system).

The capture device 103 may be responsible for monitoring and identifying driver behaviors based on captured driver motion and/or audio data using one or more capturing devices positioned within the cab, such as sensor 103A, camera 103B or microphone 103C. In one embodiment, the capture device 103 is positioned to capture motion of the driver's head and face, while in other implementations movement of the driver's torso, and/or driver's limbs and hands are also captured. For example, the detection and tracking 108A, head pose estimator 108B and gaze direction estimator 108C can monitor driver motion captured by capture device 103 to detect specific poses, such as head pose, or whether the person is looking in a specific direction.

Still other embodiments include capturing audio data, via microphone 103C, along with or separate from the driver movement data. The captured audio may be, for example, an audio signal of the driver 102 captured by microphone 103C. The audio can be analyzed to detect various features that may vary in dependence on the state of the driver. Examples of such audio features include driver speech, passenger speech, music, etc.

Although the capture device 103 is depicted as a single device with multiple components, it is appreciated that each component (e.g., sensor, camera, microphone, etc.) may be a separate component located in different areas of the vehicle 101. For example, the sensor 103A, the camera 103B, the microphone 103C and the depth sensor 103D may each be located in a different area of the vehicle's cab. In another example, individual components of the capture deice 103 may be part of another component or device. For example, camera 103B and visual/audio 118 may be part of a mobile phone or tablet (not shown) placed in the vehicle's cab, whereas sensor 103A and microphone 103C may be individually located in a different place in the vehicle's cab.

The detection and tracking 108A monitors facial features of the driver 102 captured by the capture device 103, which may then be extracted subsequent to detecting a face of the driver. The term facial features includes, but is not limited to, points surrounding eyes, nose, and mouth regions as well as points outlining contoured portions of the detected face of the driver 102. Based on the monitored facial features, initial locations for one or more eye features of an eyeball of the driver 102 can be detected. The eye features may include an iris and first and second eye corners of the eyeball. Thus, for example, detecting the location for each of the one or more eye features includes detecting a location of an iris, detecting a location for the first eye corner and detecting a location for a second eye corner.

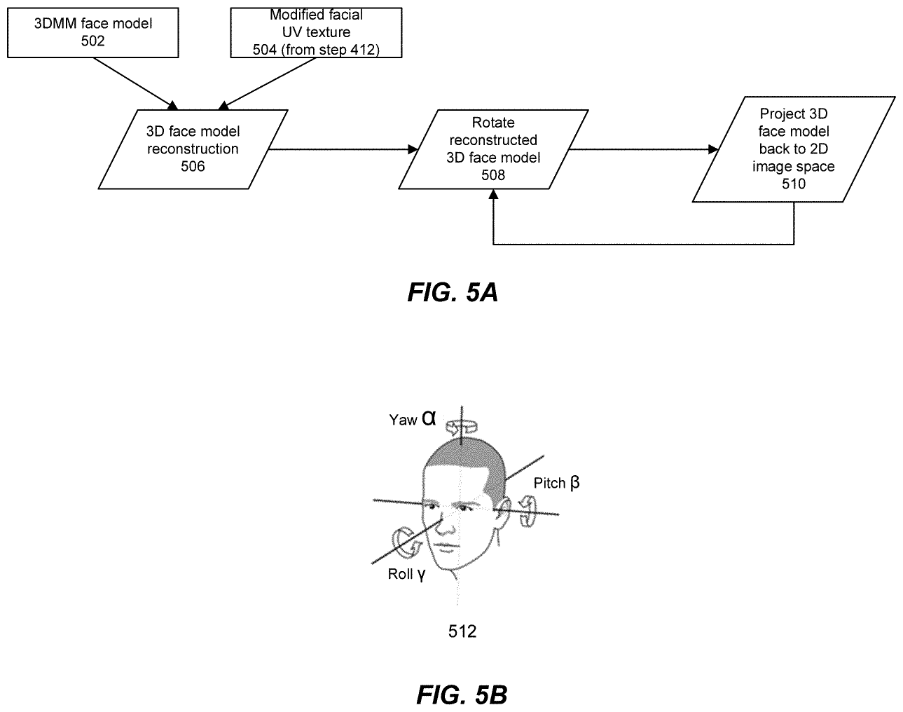

The head pose estimator 108B uses the monitored facial features to estimate a head pose of the driver 102. As used herein, the term “head pose” describes an angle referring to the relative orientation of the driver's head with respect to a plane of the capture device 103. In one embodiment, the head pose includes yaw and pitch angles of the driver's head in relation to the capture device plane. In another embodiment, the head pose includes yaw, pitch and roll angles of the driver's head in relation to the capture device plane. Head pose is described in more detail below with reference to FIG. 5B.

The gaze direction estimator 108C estimates the driver's gaze direction (and gaze angle). In operation of the gaze direction estimator 108C, the capture device 103 may capture an image or group of images (e.g., of a driver of the vehicle). The capture device 103 may transmit the image(s) to the gaze direction estimator 108C, where the gaze direction estimator 108C detects facial features from the images and tracks (e.g., over time) the gaze of the driver. One such gaze direction estimator is the eye tracking system by Smart Eye Ab®.

In another embodiment, the gaze direction estimator 108C may detect eyes from a captured image. For example, the gaze direction estimator 108C may rely on the eye center to determine gaze direction. In short, the driver may be assumed to be gazing forward relative to the orientation of his or her head. In some embodiments, the gaze direction estimator 108C provides more precise gaze tracking by detecting pupil or iris positions or using a geometric model based on the estimated head pose and the detected locations for each of the iris and the first and second eye corners. Pupil and/or iris tracking enables the gaze direction estimator 108C to detect gaze direction de-coupled from head pose. Drivers often visually scan the surrounding environment with little or no head movement (e.g., glancing to the left or right (or up or down) to better see items or objects outside of their direct line of sight). These visual scans frequently occur with regard to objects on or near the road (e.g., to view road signs, pedestrians near the road, etc.) and with regard to objects in the cabin of the vehicle (e.g., to view console readings such as speed, to operate a radio or other in-dash devices, or to view/operate personal mobile devices). In some instances, a driver may glance at some or all of these objects (e.g., out of the corner of his or her eye) with minimal head movement. By tracking the pupils and/or iris, the gaze direction estimator 108C may detect upward, downward, and sideways glances that would otherwise go undetected in a system that simply tracks head position.

In one embodiment, and based on the detected facial features, the gaze direction estimator 108C may cause the processor(s) 108 to determine a gaze direction (e.g., for a gaze of an operator at the vehicle). In some embodiments, the gaze direction estimator 108C receives a series of images (and/or video). The gaze direction estimator 108C may detect facial features in multiple images (e.g., a series or sequence of images). Accordingly, the gaze direction estimator 108C may track gaze direction over time and store such information, for example, in database 140.

The processor 108, in addition to the afore-mentioned pose and gaze detection, may also include an image corrector 108D, a video enhancer 108E, a video scene analyzer 108F and/or other data processing and analytics to determine scene information captured by capture device 103.

Image corrector 108D receives captured data and may undergo correction, such as video stabilization. For example, bumps on the roads may shake, blur, or distort the data. The image corrector may stabilize the images against horizontal and/or vertical shake, and/or may correct for panning, rotation, and/or zoom.

Video enhancer 108E may perform additional enhancement or processing in situations where there is poor lighting or high data compression. Video processing and enhancement may include, but are not limited to, gamma correction, de-hazing, and/or de-blurring. Other video processing enhancement algorithms may operate to reduce noise in the input of low lighting video followed by contrast enhancement techniques, such but not limited to, tone-mapping, histogram stretching and equalization, and gamma correction to recover visual information in low lighting videos.

The video scene analyzer 108F may recognize the content of the video coming in from the capture device 103. For example, the content of the video may include a scene or sequence of scenes from a forward facing camera 103B in the vehicle. Analysis of the video may involve a variety of techniques, including but not limited to, low-level content analysis such as feature extraction, structure analysis, object detection, and tracking, to high-level semantic analysis such as scene analysis, event detection, and video mining. For example, by recognizing the content of the incoming video signals, it may be determined if the vehicle 101 is driving along a freeway or within city limits, if there are any pedestrians, animals, or other objects/obstacles on the road, etc. By performing image processing (e.g., image correction, video enhancement, etc.) prior to or simultaneously while performing image analysis (e.g., video scene analysis, etc.), the image data may be prepared in a manner that is specific to the type of analysis being performed. For example, image correction to reduce blur may allow video scene analysis to be performed more accurately by clearing up the appearance of edge lines used for object recognition.

Vehicle system 104 may provide a signal corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System [GPS] sensors, etc.), digital signals propagated through vehicle data networks (such as an engine controller area network (CAN) bus through which engine related information may be communicated, a climate control CAN bus through which climate control related information may be communicated, and a multimedia data network through which multimedia data is communicated between multimedia components in the vehicle). For example, the vehicle system 104 may retrieve from the engine CAN bus the current speed of the vehicle estimated by the wheel sensors, a power state of the vehicle via a battery and/or power distribution system of the vehicle, an ignition state of the vehicle, etc.

Navigation system 107 of vehicle 101 may generate and/or receive navigation information such as location information (e.g., via a GPS sensor and/or other sensors 105), route guidance, traffic information, point-of-interest (POI) identification, and/or provide other navigational services for the driver. In one embodiment, the navigation system or part of the navigation system is communicatively coupled to and located remote from the vehicle 101.

Input/output interface(s) 114 allow information to be presented to the user and/or other components or devices using various input/output devices. Examples of input devices include a keyboard, a microphone, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a visual/audio alert 118, such as a display, speakers, and so forth. In one embodiment, I/O interface 114 receives the driver motion data and/or audio data of the driver 102 from the capture device 103. The driver motion data may be related to, for example, the eyes and face of the driver 102, which may be analyzed by processor(s) 108.

Data collected by the driver distraction system 106 may be stored in database 140, in memory 116 or any combination thereof. In one embodiment, the data collected is from one or more sources external to the vehicle 101. The stored information may be data related to driver distraction and safety, such as information captured by capture device 103. In one embodiment, the data stored in database 140 may be a collection of data collected for one or more drivers of vehicle 101. In one embodiment, the collected data is head pose data for a driver of the vehicle 101. In another embodiment, the collected data is gaze direction data for a driver of the vehicle 101. The collected data may also be used to generate datasets and information that may be used to train models for machine learning, such as machine learning engine 109.

In one embodiment, memory 116 can store instructions executable by the processor(s) 108, a machine learning engine 109, and programs or applications (not shown) that are loadable and executable by processor(s) 108. In one embodiment, machine learning engine 109 comprises executable code stored in memory 116 that is executable by processor(s) 108 and selects one or more machine learning models stored in memory 116 (or database 140). The machine models can be developed using well known and conventional machine learning and deep learning techniques, such as implementation of a convolutional neural network (CNN), described in more detail below.

Applying all or a portion of the collected and obtained data from the various components, the driver distraction system 106 may calculate a level of driver distraction. The level of driver distraction may be based on threshold levels input into the system or based on previously (e.g., historical) collected and obtained information that is analyzed to determine when a driver qualifies as being distracted. In one embodiment, a weight or score may represent the level of driver distraction and be based on information obtained from observing the driver, the vehicle and/or the surrounding environment. These observations may be compared against, for example, the threshold levels or previously collected and obtained information. For example, in bad weather or during rush hour or at night, the route may require a higher level of driver attention than portions of the route in the surrounding environment during good weather, non-rush hour and during the day. These portions be deemed as safe driving areas where lower levels of driver distraction are likely to occur, and distracted driving areas where higher levels of driver distraction are likely to occur. In another example, drivers may require a higher level of attention while traveling along a winding road or a highway than would be required while traveling along a straight road or a cul-de-sac. In this case, drivers traveling along the winding road or highway may have portions of the route with higher levels of driver distraction, whereas drivers traveling along a straight road or a cul-de-sac may have portions of the route of lower levels of driver distraction.

Other examples include calculating a driver distraction score when the driver is gazing forward (e.g., as determined from the internal image) versus when the driver is gazing downward or to the side. When the driver is deemed to being gazing forward, the associated score (and level of distraction) would be deemed lower than when the driver is gazing downward or to a side. Numerous other factors may be considered when calculating a score, such as how noisy the cabin of the vehicle may be (e.g., based on detected audible information) or gazing in a direction in which a hazardous or unsafe object is obstructed but otherwise detectable by the vehicle sensors (e.g., determined from vehicle proximity sensors, the external image, etc.). It is appreciated that other driver distraction scores may be calculated provided any other suitable set of inputs.

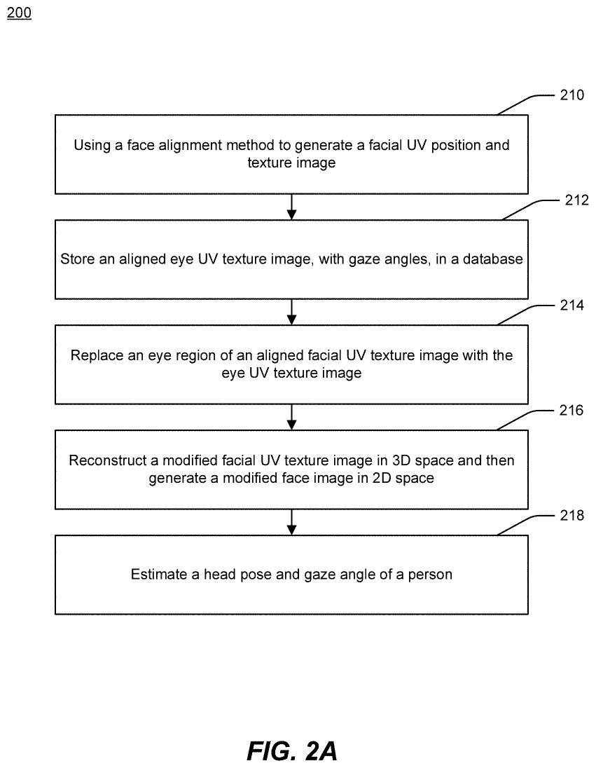

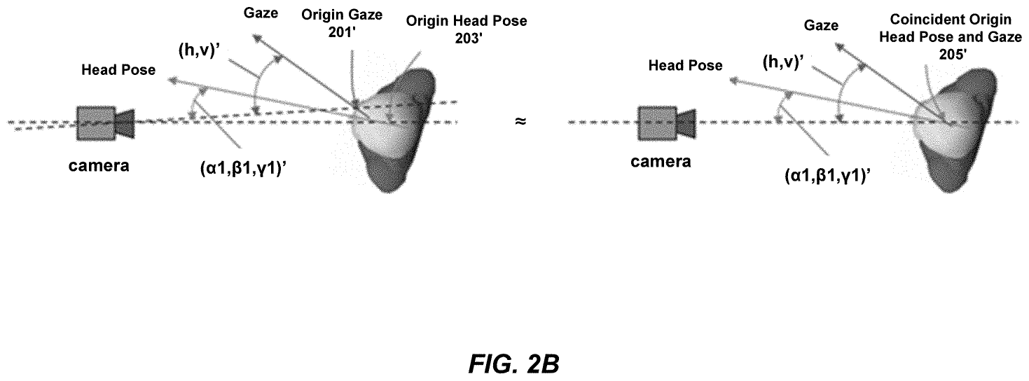

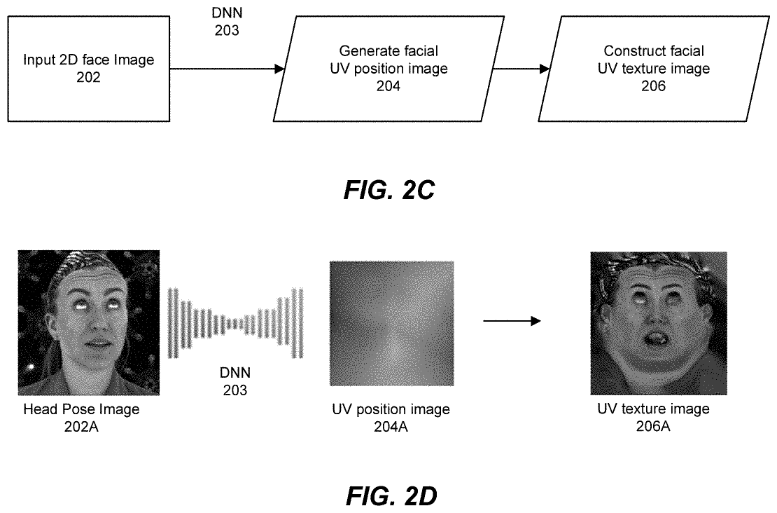

FIG. 2A illustrates an example flow diagram for estimating head pose and gaze angles in accordance with embodiments of the disclosure. In embodiments, the flow diagrams may be computer-implemented methods performed, at least partly, by hardware and/or software components illustrated in the various figures and as described herein. In one embodiment, the disclosed process may be performed by the head pose and gaze estimator 106 disclosed in FIGS. 1A and 1B. In one embodiment, software components executed by one or more processors, such as processor(s) 108 or processor 802, perform at least a portion of the process.

Process 200 estimates a head pose and gaze angle of a person, for example, a driver of a vehicle. Steps 210-216 relate to the generation of a dataset with accurate head pose and gaze angle labels, which will be used in step 218 to train a multimodal CNN for head pose and gaze angle estimation. For purposes of calculating the head pose and gaze estimation, the head pose of a person has a yaw, pitch and roll (α, β, γ) equal to (0°, 0°, 0°) when the head faces frontward toward a capture device 103, such as a camera 103B, as shown in FIG. 2B. In one embodiment, when an image of a two-dimensional (2D) face (i.e., a facial image) of the person is captured by the camera 103B, the gaze angle of the person's eyes will be determined by the position of the pupil centers with respect to the corners of the eyes.

Based on this assumption, the person's head may be aligned using different poses such that movement of the head (pose) may be de-coupled from the eyes (gaze). In one embodiment by changing the position of the pupil centers (with respect to the corners of the eyes) in the aligned image, the gaze angles can also be changed when reconstructing the 2D image, as explained below. In making these determinations, the origins of the head pose and gaze coordinates are coincident, as shown in FIG. 2B. According to the embodiment, the origin gaze 201′ and origin head pose 203′ are shown as two separate dotted lines, where the gaze angle is (h,v)′ and the head pose angle has the three rotation angles of yaw, pitch and roll (α₁, β₁, γ₁). The origin gaze 201′ and origin head pose 203′ coordinates (e.g., (h,v)′ and (α₁, β₁, γ₁)′ are equivalent (or nearly equivalent) to the coincident origin head pose and gaze 205′ (i.e., the head pose and gaze are shown as a single dotted line).

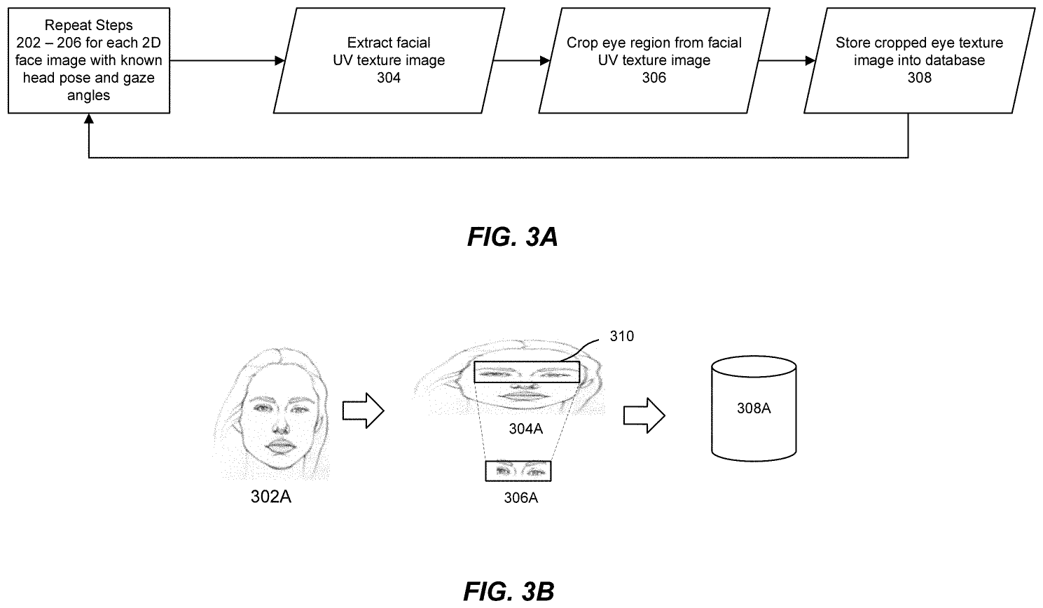

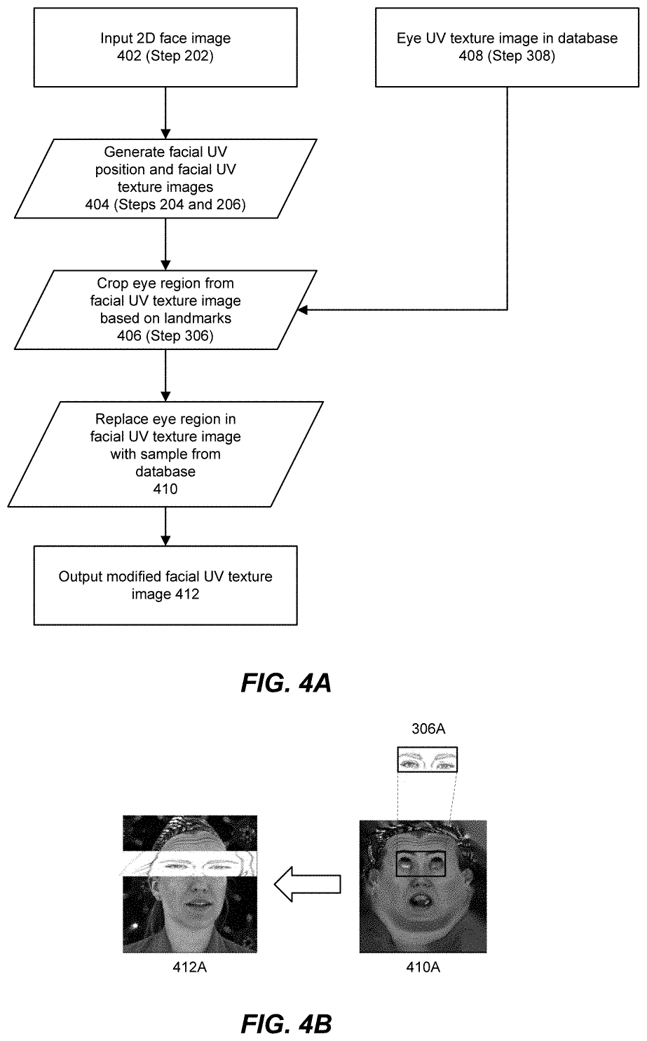

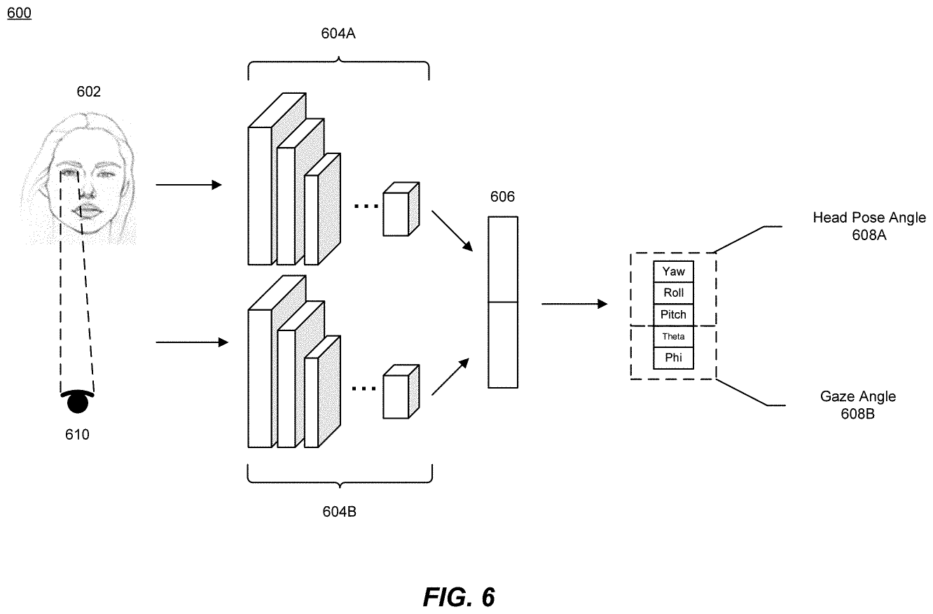

Based on the above assumptions, at step 210, a face alignment method, such as an encoder-decoder deep neural network (DNN), is trained with an image of the 2D face to generate an aligned facial UV position image and facial UV texture image of the 2D face in which to decouple movement of the head and eyes of the 2D face, as described below with reference to FIGS. 2C and 2D. An eye UV texture image, including gaze angles, is then extracted from the facial UV texture image of the 2D face and stored in a database, at step 212 (FIGS. 3A and 3B). An eye region of the facial UV texture image is replaced with the eye UV texture image, including the gaze angles, retrieved from the database at 214 (FIGS. 4A and 4B). Replacing the eye region with the eye UV texture image generates a modified facial UV texture image. At step 216, the modified facial UV texture image is reconstructed to generate a modified 2D face image, including a modified head pose and gaze angle, as training data stored in the database (FIGS. 5A and 5B), and the head pose and gaze angles of a person is estimated at step 218 by training a CNN with the training data (FIG. 6). A detailed explanation of each step is found in the description below with reference to the corresponding figures.

FIGS. 2C and 2D illustrate an example of training a neural network for two-dimensional (2D) face alignment. The training of a neural network in the depicted embodiments is a detailed description of the training step 210 of FIG. 2A. With reference to FIG. 2C, a 2D image of a face 202 is input into a deep neural network (DNN) 203, such as an encoder-decoder type DNN (or face alignment network), where the machine learning engine 109 aligns the 2D face image into a facial UV position image (or position map) 204 and constructs a facial UV texture image (or texture map) 206. That is, the facial UV position image 204 represents a full 3D facial structure of the 2D image that records 3D positions of all points in UV space while maintaining a dense correspondence to the semantic meaning of each point in UV space. As appreciated by the skilled artisan, UV space (or UV coordinates) is a 2D image plane parameterized from 3D space that may be used to express the 3D geometry (i.e., facial UV position image 204) and the corresponding texture of the face (i.e., facial UV texture image 206), wherIDSe “U” and “V” are the axes of the image plane (since “X,” “Y” and “Z” are used as coordinates in 3D space). In one embodiment, the dataset used to train the DNN 203 is a public dataset, such as the 300 W-LP (large pose) dataset. While the example refers to a neural network, it is appreciated that other face alignment methods can be used to generate the facial UV position image (or position map) 204 and then construct the corresponding facial UV texture image 206.

In one example, the 2D image is a head pose image 202A depicted in FIG. 2D that is processed by the encoder-decoder type DNN 203. For the head pose image 202A, the encoder-decoder type DNN 203 aligns the head (face) and maps the face image from 2D image space to the corresponding UV space. This results in the 2D image plane parameterized from the 3D space to express the corresponding 3D geometry (facial UV position image 204A) and the texture of the face (facial UV texture image 206A). Accordingly, movement of the head and eyes are separated such that the head pose (facial UV position image) and gaze direction (facial UV texture image) are de-coupled from one another.

In one embodiment, the above generation of the UV position image and UV texture map is implemented according to the “Joint 3D Face Reconstruction and Dense Alignment with Position Map Regression Network” by Feng et al., published March 2018 However, it is appreciated that any different number of known face alignment techniques may be used to generate the facial UV position image and facial UV texture image from the head pose image.

FIGS. 3A and 3B illustrate an example of constructing an eye UV texture dataset. The construction of the eye UV texture dataset in the depicted embodiments is a detailed description of step 212 of FIG. 2. Referring to FIGS. 3A and 3B, a head pose image (with a known head pose and gaze angle) is input into DNN 203, where steps 202-206 may be repeated for each head pose image. For example, head pose image 302A is input into DNN 203. As explained above, inputting the head pose image 302A into DNN 203 generates an aligned facial UV position image and facial UV texture image. The facial UV texture image 304A may then be extracted from the generated information at step 304. For example, facial UV texture image 304A is extracted from DNN 203 after processing the input head pose image 302A. Using the extracted facial UV texture image 304A from step 304, an eye region 310 may be cropped from the facial UV texture image 304A at step 306 to generate eye UV texture image 306A.

In one embodiment, cropping the eye region from the extracted facial UV texture image 304A is based on aligned facial landmarks (described below) determined during the facial alignment performed by DNN 203. For example, for a 2D image (i.e., head pose image) with a known head pose having angles (α₁, β₁, γ₁)′ and a gaze having angles (h,v)′, described above with reference to FIG. 2B, the difference between the head pose angles and the gaze angles will be calculated as the eye UV texture image 306A in which the eyes have been cropped. More specifically, if the 2D face image has 3D head pose Euler angles Yaw, Pitch and Roll, such that H=(α₁, β₁, γ₁)′ and gaze Euler angles Yaw and Pitch, such that G=(h, v)′, the difference can be calculated as

Δ=(θ,φ)′=(h−α₁,v−β₁)′ (1).

Each of the eye UV texture images 306A, from each of the input 2D face images, may then be used to construct the eye UV texture dataset for storage in a database, such as database 308A, at step 308. The stored eye UV texture dataset may be retrieved for subsequent processing in order to replace an eye region of a facial UV texture image with one from the database 308. In one embodiment, the eye UV texture database is constructed using any 2D face image dataset with known head pose and gaze angles, such as the Columbia gaze dataset.

FIGS. 4A and 4B illustrate an example of replacing an eye region in the facial UV texture image. The replacement of an eye region in the facial UV texture image of the depicted embodiments is a detailed description of step 214 of FIG. 2. Prior to replacing the eye region in the facial UV texture with the eye UV texture image selected from the eye UV texture image dataset stored in database 308A, a 2D face image with a known head pose (α₂, β₂, γ₂)_{′} (for example a front view face image in which (α₂, β₂, γ₂)′=(0°, 0°,0°)) is input into DNN 203 to obtain an aligned facial UV position image 204A and facial UV texture image 206A at steps 402 and 404 (corresponding to steps 202-206 in FIG. 2C).

At step 406 (corresponding to step 306 in FIG. 3A), an eye region 310 is then cropped from the aligned facial UV texture image 304A based on the UV space (coordinates) of eye landmarks. The UV space of the eye landmarks used to crop the eye region 310 are directly determined by DNN 203 during the generation of the UV position image 204A and UV texture image 206A. In one embodiment, the UV space of the eye landmarks may be determined using any number of different well-known facial alignment or facial landmark localization techniques, such as but not limited to regression techniques, active appearance models (AAM), active shape models (ASM), constrained local models (CLM), mnemonic descent method and cascaded auto-encoders, cascaded CNNs, generative adversarial network (GAN), etc.

The eye region 310 cropped from the facial UV texture image in step 404 is then replaced with an eye region 310 with an eye UV texture selected from the database 308A storing the eye UV textures, as detailed above with reference to FIGS. 3A and 3B. For example, the cropped eye region 306A is selected from the eye UV texture image in database 308A at step 408 (corresponding to step 308 in FIG. 3A) and replaces the eye region of the facial UV texture image 410A, as shown in FIG. 4B. The resulting image is a modified facial UV texture map 412A that is output for processing at steps 502-506 of FIG. 5A.

In one other embodiment, replacing the eye region 310 of the facial UV texture image 410A is accomplished using Gaussian mixture image compositing. It is appreciated that any number of different eye region replacement techniques may be employed, as readily appreciated by the skilled artisan.

In some embodiment, replacing the eye region of the facial UV texture image with an eye UV texture image from the database 308A causes at least some visual discontinuity in color distributions and/or textures due to different imaging conditions between the currently input 2D face image at step 402 and the selected eye UV texture image 306A from database 308A. To absolve this visual discontinuity, a gradient-based image fusion algorithm may be used to merge the selected eye UV texture image 306A into the aligned facial UV texture image 410A. For example, the image fusion technique may use the gradient-based approach to preserve important local perceptual cues while at the same time avoid traditional problems such as aliasing, ghosting and haloing. One example of such a technique is described in “Image Fusion for Context Enhancement and Video Surrealism” to Raskar, et al., published April 2004, which may be used to merge (fuse) the two images. In one further embodiment, a generative adversarial network (GAN) can be trained to smoothly modify the local color/texture details in the eye region in order to perform the replacement step. That is, the GAN may improve the realism of images from a simulator using unlabeled real data, while preserving annotation information.

FIGS. 5A and 5B illustrate an example flow diagram of 3D face reconstruction and training data generation. The 3D face reconstruction and training data generation in the depicted embodiments is a detailed description of step 216 of FIG. 2. After outputting the modified UV texture image for a 2D face image (step 412 of FIG. 4A), a dataset (e.g., a 2D photorealistic synthetic dataset) may be generated by reconstructing a 3D face model, rotating the reconstructed 3D face model and projecting the rotated 3D face model back to a 2D image space, as explained below with reference to steps 502-510.

At step 506, the modified facial UV texture 412A at step 504 (corresponding to step 412 of FIG. 4A) is warped onto a 3D face morphable model (3DMM) of step 502 to reconstruct a 3D face model 512 of the person's head with a modified gaze direction, as shown in FIG. 5B. In one embodiment, a 2D face image, such as 2D face image 202A (FIG. 2D), is fit to a 3DMM by modeling the 3D face shape with a linear subspace (using a principal component analysis (PCA) or Tensor) and achieves such fit by minimizing the difference between the image and the model appearance. In one variation, a regression based 3DMM fitting may be applied such that the model parameters are estimated by regressing the features at landmark positions. Examples of warping 2D face images onto a 3DMM may be found in “Face alignment across large poses: a 3D solution” by Zhu et al., published November 2015, and “Appearance-based gaze estimation in the wild” by Zhang et al., published October 2015.

While a facial UV position image may be used to reconstruct the 3D face model 512, other techniques may also be utilized. For example, the 3D dense face alignment (3DDFA) framework can also be used to reconstruct the 3D face model 512. In another example, a face alignment technique may be used to reconstruct the 3D face model 512. Such a technique is described in “How far are we from solving the 2D & 3D face alignment problem? (and a dataset of 230,000 3D facial landmarks)” to Bulat et al., published March 2017.

After reconstruction, a rotation matrix R is then applied to the reconstructed 3D face model 512 in order to change the person's head pose at step 508. Changing the head pose also changes the gaze angle of the person's eyes as the reconstructed 3D face model is considered a rigid object. After rotation, the 3D face model 512 is projected back to 2D image space at step 510. It is appreciated that other projection techniques may be applied in step 510. For example, the 3D face model 512 may be directly projected to a 2D plane and artificial backgrounds added thereto. In another example, a 3D image meshing method to rotate the head and project the 3D head back to 2D may be employed. Such a technique is disclosed in “Face alignment across large poses: a 3D solution” to Zhu et al.

In one embodiment, the generated 2D face image has a known head pose (α2+α3, β2+β3, γ2+γ3) based on the rotation matrix R, and the gaze direction (α2+α3+θ, β2+β3+φ) can be obtained by adding the relative gaze direction of the selected eye UV texture image from the database 308A to the head pose. For example, when (α=0, β3=0, γ3=0), the gaze angle will be changed to (α2+θ, β2+φ)′ while the head pose will remain the same.

With reference to FIG. 5B, if the 3 Euler angles (yaw, pitch and roll) of the rotation applied to the reconstructed 3D face model 512 is (α₃, β₃, γ₃), then the rotation matrix R can be written as:

$$R = {R}_{y} ( {α}_{3} ) {R}_{x} ( {β}_{3} ) {R}_{z} ( {γ}_{3} ) , \\ where \\ {R}_{y} ( {α}_{3} ) = [ \begin{matrix}{cosα}_{3} & 0 & {sinα}_{3} \\ 0 & 1 & 0 \\ - {sinθα}_{3} & 0 & {cosθα}_{3}\end{matrix} ] \\ {R}_{x} ( {β}_{3} ) = [ \begin{matrix}1 & 0 & 0 \\ 0 & {cosβ}_{3} & - {sinβ}_{3} \\ 0 & {sinβ}_{3} & {cosβ}_{3}\end{matrix} ] \\ {R}_{z} ( {γ}_{3} ) = [ \begin{matrix}{cosγ}_{3} & {sinγ}_{3} & 0 \\ - {sinγ}_{3} & {cosγ}_{3} & 0 \\ 0 & 0 & 1\end{matrix} ] . \qquad ( 2 )$$

The three matrices represent the basic rotation matrix about X, Y and Z axis, as illustrated. For any point V=[x, y, z]^{T} on the 3D face model, after rotation, the point V becomes

$${V}^{′} = [ \begin{matrix}{x}^{′} \\ {y}^{′} \\ {z}^{′}\end{matrix} ] = RV = {R}_{y} ( {α}_{3} ) {R}_{x} ( {β}_{3} ) {R}_{z} ( {γ}_{3} ) [ \begin{matrix}x \\ y \\ z\end{matrix} ] . \qquad ( 3 )$$

After rotation, the new head pose can be computed as:

H′=(α₂α₃,β₂+β₃,γ₂+γ₃) (4),

and the gaze angle can be calculated as:

G′=(α₂+α₃+θ,β₂+β₃+φ) (5).

To project the 3D face model 512 after rotation back to 2D image space at step 510, a camera intrinsic matrix is applied to the 3D face model 512 according to:

$$s [ \begin{matrix}u \\ v \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{x}^{′} \\ {y}^{′} \\ {z}^{′}\end{matrix} ] ,$$

where [x′, y′, z′]^{T} is the new 3D space (coordinates) after rotation, fₓ and f_{y} are the focal lengths expressed in pixel units, (cₓ, c_{y}) is a principal point that is typically at the image center,s is the scale factor and [u, v]^{T} is the coordinates of the corresponding point on the 2D image.

To generate a dataset of 2D face images (e.g., the 2D photorealistic synthetic dataset) with head pose and gaze angles, the rotation operation at step 508 is repeated for each 3D face model reconstructed from the 3DMM face model and modified facial UV texture. The resulting dataset may then be stored as the 2D photorealistic synthetic dataset, for example, in a database.

FIG. 6 illustrates an example of a multimodal CNN for estimating head pose and gaze angle. The CNN 600 for simultaneous estimation of head pose and gaze angle in the depicted embodiments is a detailed description of step 218 of FIG. 2A. The CNN 600 will be trained end-to-end using the 2D photorealistic synthetic dataset generated during step 510 of FIG. 5A. As illustrated, the CNN 600 receives two inputs: a 2D face image 602 and an eye region 610 of the 2D face image 602. Each of the inputs is passed to separately stacked convolution layers 604A and 604B, where batch normalization and activation functions may be applied. For example, in one embodiment, each convolutional layer 604A and 604B is followed by a batch normalization (BN) layer (not shown). Each convolutional layer 604A and 604B simultaneously extracts deeper features based on input features provided by the previous layer and automatically learn task related feature representations of the 2D face image 602 and eye region 610. The extracted features (i.e., head pose and gaze) from each input are flattened and merged for input into the fully connected layers 606 in which to estimate the head pose angle 608A (e.g., yaw, roll, pitch) and gaze angle 608B (e.g., theta, phi) of the 2D face image input from the 2D photorealistic synthetic dataset. In one embodiment, processing the inputs in the manner described above may also be referred to as applying transformations to the input data. More generally, as the input data is processed by the CNN 600, transformations are applied at different layers of the network. These transformations may be linear transformations, statistical standardization or other mathematical functions. Non-limiting examples of transformation include mirroring, rotating, smoothing, contrast reduction, and the like that may be applied to the input data.

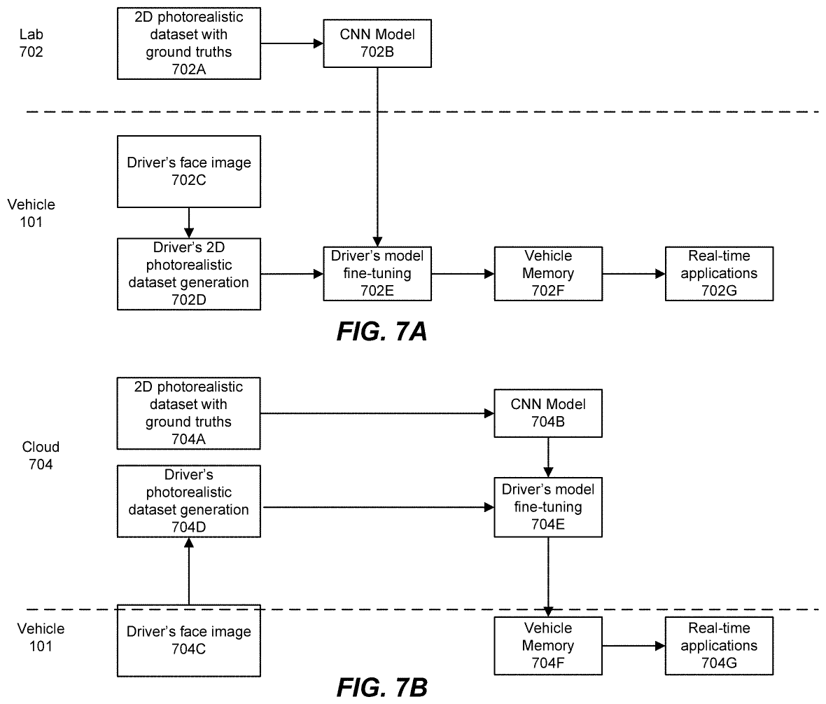

FIGS. 7A and 7B illustrate flow diagrams to fine-tune a pre-trained model. In one embodiment, and with reference to FIG. 7A, a driver 102 in a vehicle 101 (FIG. 1) can provide images with the driver's head pose to fine-tune the CNN model. A dataset 702A (e.g., 2D photorealistic synthetic dataset), generated according to the aforementioned steps, is used to train a CNN, such as CNN 600, in the lab 702 (or any other location in which a processing device is located). The trained CNN model 702B may be stored, for example, into vehicle memory 702F of vehicle 101. The driver 102 of the vehicle 101 will have 2D face images 702C captured. In real applications, such as real-time applications 702G, in order to preserve more details of the driver's facial texture, the subject's front view face images will be captured as much as possible. The 2D face images of the driver 102 may be taken by a capture device 103 within the vehicle 101. The capture device 103 may be part of the vehicle, such as a sensor 103A or camera 103B, depth sensor 103D, or place in the vehicle, such as a mobile phone or tablet. In one embodiment, the 2D face images are captured while the driver 102 is driving the vehicle 101. In another embodiment, the 2D face images are captured while the vehicle 101 is parked or in a non-moving state. The captured 2D face images of the driver may then be used to generate a driver dataset 702D (e.g., a driver 2D photorealistic dataset) using the aforementioned steps (e.g., the steps in FIGS. 2A-6). In one embodiment, the driver dataset 702D may be stored in the vehicle memory 702F. The driver dataset 702D will be applied to fine-tune the CNN model 702B using the driver's model fine-tuning 704E for a more accurate head pose and gaze angle estimation for the driver 102 and for use during real-time application 702G, such as during driving the vehicle 101.

In one other embodiment, and with reference to FIG. 7B, a driver 102 of a vehicle 101 (FIG. 1) can provide images with the driver's head pose to fine-tune the CNN model. Unlike the embodiment of FIG. 7A, the driver 102 can capture 2D face images 704C prior to driving the vehicle 101. In real applications, such as real-time applications 704G, in order to preserve more details of the driver's facial texture, the subject's front view face images will be captured as much as possible. In one embodiment, a capture device 103, such as camera 103B, depth sensor 103D or a mobile phone or tablet, may be used to capture the 2D face images 704C. The captured 2D face images 704C can then be uploaded to the cloud 704 where a dataset 704D (e.g., 2D photorealistic synthetic dataset) may be generated with different pose and gaze angles for the driver 102 (based on different 2D face images being uploaded) according to the steps in FIGS. 2A-6). In cloud 704, a CNN model 704B is pre-trained using a large dataset 704A (which may be saved in a database) generated according to the steps in FIGS. 2A-6) with different subjects, such as CNN 600. Subsequently, the driver dataset 704D will be applied to fine-tune the pre-trained CNN model 704B for a more accurate head pose and gaze angle estimation for the driver 102. The fine-tuned CNN model 704E may be downloaded to the vehicle 101 and stored, for example, into vehicle memory 704F and for use during real-time application 704G, such as during driving the vehicle 101.

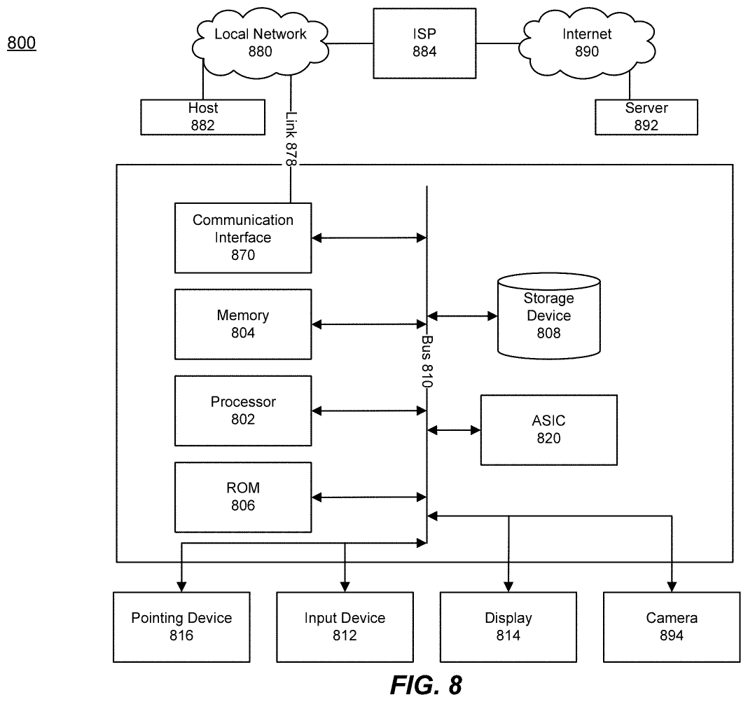

FIG. 8 illustrates a computing system upon embodiments of the disclosure may be implemented. Computing system 800 may be programmed (e.g., via computer program code or instructions) to provide enhanced safety to drivers using driver behavior detection as described herein and includes a communication mechanism such as a bus 810 for passing information between other internal and external components of the computer system 800. In one embodiment, the computer system 800 is system 100 of FIG. 1A. Computer system 800, or a portion thereof, constitutes a means for performing one or more steps for providing enhanced safety to drivers using the driver behavior detection.

A bus 810 includes one or more parallel conductors of information so that information is transferred quickly among devices coupled to the bus 810. One or more processors 802 for processing information are coupled with the bus 810.

One or more processors 802 performs a set of operations on information (or data) as specified by computer program code related to providing enhanced safety to drivers using driver behavior detection. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions.

Computer system 800 also includes a memory 804 coupled to bus 810. The memory 804, such as a random access memory (RAM) or any other dynamic storage device, stores information including processor instructions for providing enhanced safety to drivers using driver behavior detection. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information. Also coupled to bus 810 is a non-volatile (persistent) storage device 808, such as a magnetic disk, optical disk or flash card, for storing information, including instructions.

In one embodiment, information, including instructions for providing enhanced safety to distracted drivers using the head pose and gaze estimator, is provided to the bus 810 for use by the processor 802 from an external input device 812, such as a keyboard operated by a human user, a microphone, an Infrared (IR) remote control, a joystick, a game pad, a stylus pen, a touch screen, head mounted display or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814 for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings.

In the illustrated embodiment, special purpose hardware, such as an application specific integrated circuit (ASIC) 820, is coupled to bus 810. The special purpose hardware is configured to perform operations not performed by processor 802 quickly enough for special purposes.

Computer system 800 also includes a communications interface 870 coupled to bus 810. Communication interface 870 provides a one-way or two-way communication coupling to a variety of external devices that operate with their own processors. In general the coupling is with a network link 878 that is connected to a local network 880 to which a variety of external devices, such as a server or database, may be connected. Alternatively, link 878 may connect directly to an Internet service provider (ISP) 884 or to network 890, such as the Internet. The network link 878 may be wired or wireless. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends and/or receives electrical, acoustic or electromagnetic signals, including infrared and optical signals, which carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to a communication network for providing enhanced safety to distracted drivers using the head pose and gaze estimator to mobile devices, such as mobile phones or tablets.

Network link 878 typically provides information using transmission media through one or more networks to other devices that use or process the information. For example, network link 878 may provide a connection through local network 880 to a host computer 882 or to equipment 884 operated by an ISP. ISP equipment 884 in turn provide data communication services through the public, world-wide packet-switching communication network of networks now commonly referred to as the Internet 890.

A computer called a server host 882 connected to the Internet hosts a process that provides a service in response to information received over the Internet. For example, server host 882 hosts a process that provides information representing video data for presentation at display 814. It is contemplated that the components of system 800 can be deployed in various configurations within other computer systems, e.g., host 882 and server 892.

At least some embodiments of the disclosure are related to the use of computer system 800 for implementing some or all of the techniques described herein. According to one embodiment of the disclosure, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for head pose and gaze angle estimation, comprising:
training a first neural network with a plurality of two-dimensional (2D) face images in which to decouple movement of the head and eyes of a 2D face, the training of the first neural network including:
mapping the 2D face from the plurality of 2D face images to a facial position image, and
constructing a facial texture image of the 2D face based on the facial position image;
storing an eye texture image, including gaze angles, extracted from the facial texture image of the 2D face in a database;
replacing an eye region of the facial texture image with the eye texture image, including the gaze angles, stored in the database to generate a modified facial texture image;
reconstructing the modified facial texture image to generate a modified 2D face image, including a modified head pose and gaze angle, as training data and storing the training data in the database; and
estimating the head pose and gaze angles by training a second neural network with the training data, the training of the second neural network including:
collecting the training data from the database, and
simultaneously applying one or more transformations to the modified 2D face images and a corresponding eye region of the modified 2D face images of the training data.

2. The computer-implemented method of claim 1, wherein
the mapping further includes mapping the 2D face in the plurality of 2D face images to a position map using a face alignment method, where the facial position image aligns the 2D face in the plurality of 2D face images to three-dimensional (3D) coordinates of a reconstructed 3D model for the 2D face in the plurality of 2D face images; and
the constructing further includes constructing, based on the facial position image or a face 3D morphable model, the facial texture image for the 2D face in the plurality of 2D face images to indicate a texture of the aligned 2D face.

3. The computer-implemented method of claim 1, wherein the storing further includes:
extracting the facial texture image from the 2D face in the plurality of 2D face images based on the facial position image;
cropping the eye region from the facial texture image to create a cropped eye texture image based on landmarks from the aligned 2D face in the plurality of 2D face images; and
storing the cropped eye texture image into the database.

4. The computer-implemented method of claim 3, wherein the cropped eye texture image is labelled as a difference between the head pose and the gaze angle of the 2D face in the plurality of 2D face images.

5. The computer-implemented method of claim 3, wherein the replacing further includes:
selecting the eye region from the cropped eye texture image based on the landmarks from the database; and
replacing the eye region in the facial texture image with the cropped eye texture image from the database based on aligned coordinates of the landmarks to generate a modified facial texture map of the 2D face in the plurality of 2D face images.

6. The computer-implemented method of claim 3, wherein the replacing further includes:
applying image fusion to merge the cropped eye texture image selected from the database into the modified facial texture map of the 2D face in the plurality of 2D face images; and
training a generative adversarial network (GAN) or using a local gradient information-based method to smooth color and texture in the eye region of the modified facial texture image.

7. The computer-implemented method of claim 1, further comprising:
warping the modified facial texture image of the 2D face onto a 3D face morphable model (3DMM) to reconstruct a 3D face model with a gaze direction from the modified facial texture image;
applying a rotation matrix to the reconstructed 3D face model to change the head pose, and changing the gaze angles to be consistent with the head pose;
projecting the 3D face model after application of the rotation matrix to a 2D image space to generate the modified 2D face image; and
storing the modified 2D face image in the database.

8. The computer-implemented method of claim 7, wherein the gaze direction is calculated by adding a relative gaze direction stored in the cropped eye texture image selected from the database to the head pose.

9. The computer-implemented method of claim 1, wherein the estimating further includes:
collecting 2D face images of a driver of a vehicle with one or more head poses to generate a driver dataset; and
applying the driver dataset to fine-tune the second neural network to estimate the head pose and gaze angle estimation of the driver.

10. The computer-implemented method of claim 9, wherein the 2D face images of the driver are captured with a capture device and uploaded to a network for processing; and the processed 2D face images of the driver are downloaded to the vehicle.

11. The computer-implemented method of claim 1, wherein the first neural network is an encoder-decoder type neural network to map the 2D face image to a corresponding position map.

12. The computer-implemented method of claim 1, wherein in the facial position image, red green blue (RGB) gray-values at each pixel indicate 3D coordinates of the corresponding facial point in its reconstructed 3D model.

13. A device for head pose and gaze angle estimation, comprising:
a non-transitory memory storage comprising instructions; and
one or more processors in communication with the memory, wherein the one or more processors execute the instructions to:
train a first neural network with a plurality of two-dimensional (2D) face images in which to decouple movement of the head and eyes of a 2D face, the training of the first neural network including:
mapping the 2D face from the plurality of 2D face images to a facial position image, and
constructing a facial texture image of the 2D face based on the facial position image;
store an eye texture image, including gaze angles, extracted from the facial texture image of the 2D face in a database;
replace an eye region of the facial texture image with the eye texture image, including the gaze angles, stored in the database to generate a modified facial texture image;
reconstruct the modified facial texture image to generate a modified 2D face image, including a modified head pose and gaze angle, as training data and storing the training data in the database; and
estimate the head pose and gaze angles by training a second neural network with the training data, the training of the second neural network including
collecting the training data from the database, and
simultaneously applying one or more transformations to the modified 2D face images and a corresponding eye region of the modified 2D face images of the training data.

14. The device of claim 13, wherein the one or more processors further execute the instructions to:
the mapping further includes mapping the 2D face in the plurality of 2D face images to a position map using a face alignment method, where the facial position image aligns the 2D face in the plurality of 2D face images to 3D coordinates of a reconstructed 3D model for the 2D face in the plurality of 2D face images; and
the constructing further includes, based on the facial position image or a face 3D morphable model, the facial texture image for the 2D face in the plurality of 2D face images to indicate a texture of the aligned 2D face.

15. The device of claim 13, wherein the one or more processors further execute the instructions to:
extract the facial texture image from the 2D face in the plurality of 2D face images based on the position map;
crop an eye region from the facial texture image to create a cropped eye texture image based on landmarks from the aligned 2D face in the plurality of 2D face images; and
store the cropped eye texture image into the database.

16. The device of claim 15, wherein the cropped eye texture image is labelled as a difference between the head pose and the gaze angle of the 2D face in the plurality of 2D face images.

17. The device of claim 15, wherein the one or more processors further execute the instructions to:
select the eye region from the cropped eye texture image based on the landmarks from the database; and
replace the eye region in the facial texture image with the cropped eye texture image from the database based on aligned coordinates of the landmarks to generate a modified facial texture map of the 2D face in the plurality of 2D face images.

18. A non-transitory computer-readable medium storing computer instructions for head pose and gaze angle estimation, that when executed by one or more processors, cause the one or more processors to perform the steps of:
training a first neural network with a plurality of two-dimensional (2D) face images in which to decouple movement of the head and eyes of a 2D face, the training of the first neural network including:
mapping the 2D face from the plurality of 2D face images to a facial position image, and
constructing a facial texture image of the 2D face based on the facial position image;
storing an eye texture image, including gaze angles, extracted from the facial texture image of the 2D face in a database;
replacing an eye region of the facial texture image with the eye texture image, including the gaze angles, stored in the database to generate a modified facial texture image;
reconstructing the modified facial texture image to generate a modified 2D face image, including a modified head pose and gaze angle, as training data and storing the training data in the database; and
estimating the head pose and gaze angles by training a second neural network with the training data, the training of the second neural network including
collecting the training data from the database, and
simultaneously applying one or more transformations to the modified 2D face images and a corresponding eye region of the modified 2D face images of the training data.

19. The non-transitory computer-readable medium of claim 18, wherein
the mapping further includes mapping the 2D face in the plurality of 2D face images to a position map using a face alignment method, where the facial position image aligns the 2D face in the plurality of 2D face images to 3D coordinates of a reconstructed 3D model for the 2D face in the plurality of 2D face images; and
the constructing further includes constructing, based on the facial position image or a face 3D morphable model, the facial texture image for the 2D face in the plurality of 2D face images to indicate a texture of the aligned 2D face.

20. The non-transitory computer-readable medium of claim 18, wherein the storing includes:
extracting the facial texture image from the 2D face in the plurality of 2D face images based on the facial position image;
cropping the eye region from the facial texture image to create a cropped eye texture image based on landmarks from the aligned 2D face in the plurality of 2D face images; and
storing the cropped eye texture image into the database.
